(19) United States
(12) Patent Application Publication
(10) Pub. No.: US 2011/0244860 A1
(43) Pub. Date: Oct. 6, 2011

(54) Method of Changing Primary Component Carrier and Related Communication Device

(76) Inventor: Chih-Hsiang Wu, Taoyuan County (TW)

(21) Appl. No.: 13/076,452

(22) Filed: Mar. 31, 2011

Related U.S. Application Data
(60) Provisional application No. 61/320,326, filed on Apr. 2, 2010.

(51) Int. Cl. H04W 36/00

(52) U.S. Cl. 455/436

(57) ABSTRACT

A method of changing a primary component carrier (PCC) for a mobile device in a wireless communication system is disclosed. The method comprises receiving a handover command from a network of the wireless communication system to change a first uplink primary component carrier of a first plurality of uplink component carriers or a first downlink primary component carrier of a first plurality of downlink component carriers, and performing a random access channel (RACH) procedure on at least one of uplink component carriers according to the handover command.

### CROSS REFERENCE TO RELATED APPLICATIONS

This application claims the benefit of U.S. Provisional Application No. 61/320,326, filed on Apr. 2, 2010 and entitled “Method and apparatus for changing PCC in a wireless communication system” the contents of which are incorporated herein in their entirety.

### BACKGROUND OF THE INVENTION

1. Field of the Invention

The present invention relates to a method used in a wireless communications system and related communication device, and more particularly, to a method of changing primary component carrier in a wireless communications system and related communication device.

2. Description of the Prior Art

A long-term evolution (LTE) system, initiated by the third generation partnership project (3GPP), is now being regarded as a new radio interface and radio network architecture that provides a high data rate, low latency, packet optimization, and improved system capacity and coverage. In the LTE system, a radio access network known as an evolved universal terrestrial radio access network (E-UTRAN) includes a plurality of evolved Node-Bs (eNBs) for communicating with a plurality of user equipments (UEs) and communicates with a core network including a mobility management entity (MME), serving gateway, etc for NAS (Non Access Stratum) control.

The main purpose of a handover procedure is to maintain an ongoing connection which may be used for handling voice or data while the UE continuously moves. Since the UE may occasionally moves from the coverage of one cell to the coverage of another cell, the ongoing connection must be transferred correspondingly to maintain the connectivity. Based on the measurement reports provided by the UE which include information of signal quality related to the current cell and neighbor cells, the eNB determines whether the handover procedure should be initiated. The eNB performs the handover procedure by sending the UE radio resource control (RRC) context information to neighbor cells and receiving corresponding radio resource configurations from neighbor cells. According to radio resource configurations, the eNB transmits a handover command to the UE, and the UE performs the handover procedure including a radio access channel (RACH) procedure in a target cell according to the handover command. Please note that, there is no dedicated handover command in the LTE system, a RRCConnectionReconfiguration message including a mobilityControlinfo is treated as the handover command to trigger the UE to perform the handover procedure.

The random access channel (RACH) procedure is performed by the UE to acquire uplink (UL) synchronization. The UE performs the RACH procedure by transmitting a random access preamble to the target eNB, receiving a corresponding random access response from the target eNB, and validating a preamble number included in the random access response. Then, the UE can transmit a resource request or a handover complete to the target eNB using resources indicated in the random access response. After a grant corresponding to the resource request or the handover complete is received from the target eNB, the UE is able to transmit and receive the data. Therefore, it is important for the UE to complete the RACH procedure.

A long term evolution-advanced (LTE-A) system, as its name implies, is an evolution of the LTE system. The LTE-A system targets faster switching between power states, improves performance at a cell edge, and includes subjects, such as bandwidth extension, coordinated multipoint transmission/reception (CoMP), UL multiple-input multiple-output (MIMO), etc.

For bandwidth extension, carrier aggregation is introduced to the LTE-A system by which two or more component carriers are aggregated to achieve a wider-band transmission. Accordingly, the LTE-A system can support a wider bandwidth up to 100 MHz by aggregating a maximum number of 5 component carriers, where bandwidth of each component carrier is 20 MHz and is backward compatible with 3GPP Rel-8. An LTE-A specification supports carrier aggregation for both continuous and non-continuous component carriers with each component carrier limited to a maximum of 110 resource blocks. The carrier aggregation increases a bandwidth flexibility by aggregating the non-continuous component carriers. A component carrier is used as an UL component carrier or a downlink (DL) component carrier. Further, there is a one-to-one correspondence between the UL component carrier and the DL component carrier, i.e., each UL component carrier is paired with a corresponding DL component carrier. In an LTE-A time-division duplex (TDD) system, the UL component carrier and DL component carrier are the same component carrier.

When the UE is configured with the carrier aggregation, the UE is allowed to receive and transmit data on one or multiple component carriers to increase the data rate. In the LTE-A system, it is possible for the eNB to configure the UE different numbers of UL and DL component carriers which depend on UL and DL aggregation capabilities, respectively. Moreover, the component carriers configured to the UE necessarily consists of one DL primary component carrier (PCC) and one UL primary component carrier. Component carriers other than the primary component carriers are named UL or DL secondary component carriers (SCCs). The numbers of UL and DL secondary component carriers are arbitrary, and are related to the UE capability and available radio resource. The UL and DL primary component carriers are used for establishing and re-establishing the radio resource control (RRC), and transmitting and receiving the system information. The UL or DL primary component carrier can not be de-activated, but can be changed by a handover procedure with the RACH procedure. However, component carriers on which the UE can perform the RACH procedure have not been known and the process of changing UL or DL primary component carrier can not be completed without performing the RACH procedure.

### SUMMARY OF THE INVENTION

The disclosure therefore provides a method and related communication device for changing primary component carrier, to specify component carriers on which a random access channel procedure can be performed.

A method of changing a primary component carrier (PCC) for a mobile device in a wireless communication system is disclosed. The method comprises receiving a handover command from a network of the wireless communication system to change a first uplink primary component carrier of a first plurality of uplink component carriers or a first downlink primary component carrier of a first plurality of downlink component carriers, and performing a random access channel (RACH) procedure on at least one of uplink component carriers according to the handover command.

A communication device of a wireless communication system for changing a primary component carrier (PCC) is disclosed. The communication device comprises a processor for executing a program, and a memory coupled to the processor for storing the program. The program instructs the processor to perform steps of receiving a handover command from a network of the wireless communication system to change a first uplink primary component carrier of a first plurality of uplink component carriers or a first downlink primary component carrier of a first plurality of downlink component carriers, and performing a random access channel (RACH) procedure on at least one of uplink component carriers according to the handover command.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communications system according to an example of the present disclosure.

FIG. 2 is a schematic diagram of a communication device according to an example of the present disclosure.

FIG. 3 is a flowchart of a process according to an example of the present disclosure.

FIG. 4 is a schematic diagram of carrier aggregation according to an example of the present disclosure.

### DETAILED DESCRIPTION

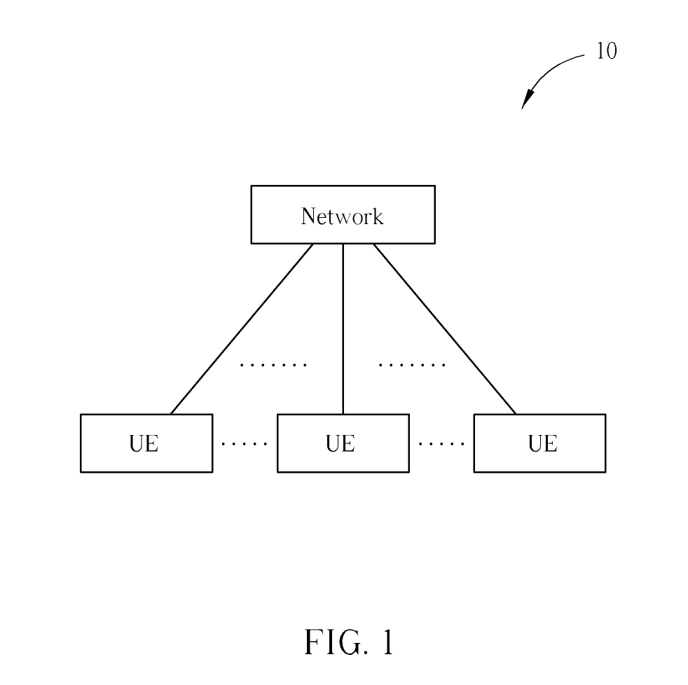

Please refer to FIG. 1, which is a schematic diagram of a wireless communication system 10 according to an example of the present disclosure. The wireless communication system 10, such as a long term evolution-advanced (LTE-A) system or other mobile communication systems supporting a carrier aggregation, is briefly composed of a network and a plurality of user equipments (UEs). In FIG. 1, the network and the UEs are simply utilized for illustrating the structure of the wireless communication system 10. Practically, the network can be referred as to an E-UTRAN (evolved-UTAN) comprising a plurality of evolved Node-Bs (eNBs) and relays in the LTE-A system. The UEs can be devices such as mobile phones, laptops, tablet computers, electronic books, and portable computer systems. Besides, the network and the UE can be seen as a transmitter or receiver according to transmission direction, e.g., for an uplink (UL), the UE is the transmitter and the network is the receiver, and for a downlink (DL), the network is the transmitter and the UE is the receiver.

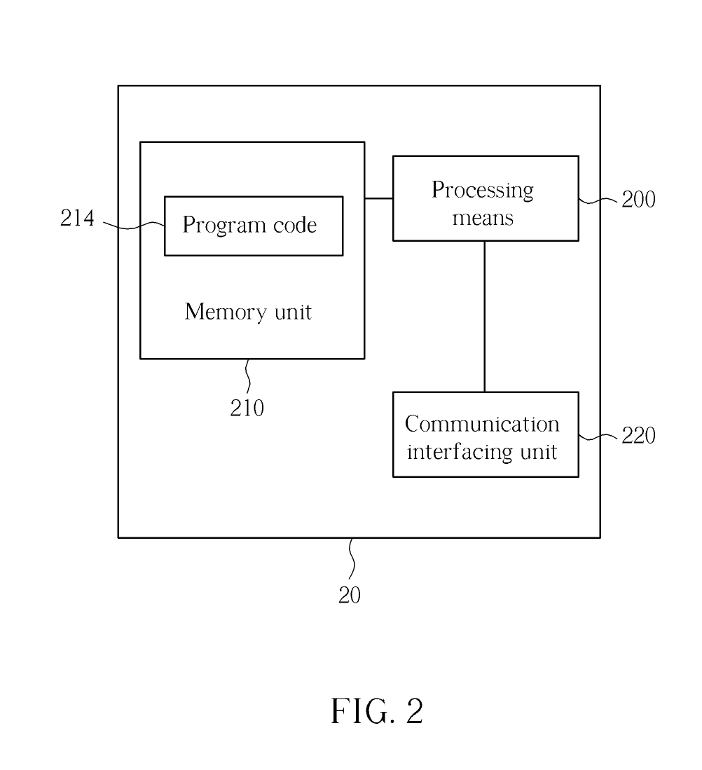

Please refer to FIG. 2, which is a schematic diagram of a communication device 20 according to an example of the present disclosure. The communication device 20 can be the UE or the network shown in FIG. 1, but is not limited herein. The communication device 20 may include a processing means 200 such as a microprocessor or Application Specific Integrated Circuit (ASIC), a memory unit 210 and a communication interfacing unit 220. The memory unit 210 may be any data storage device that can store a program code 214, accessed by the processing means 200. Examples of the memory unit 210 include but are not limited to a subscriber identity module (SIM), read-only memory (ROM), flash memory, random-access memory (RAM), CD-ROM/DVD-ROM, magnetic tape, hard disk, and optical data storage device. The communication interfacing unit 220 is preferably a radio transceiver and can exchange wireless signals with the network according to processing results of the processing means 200.

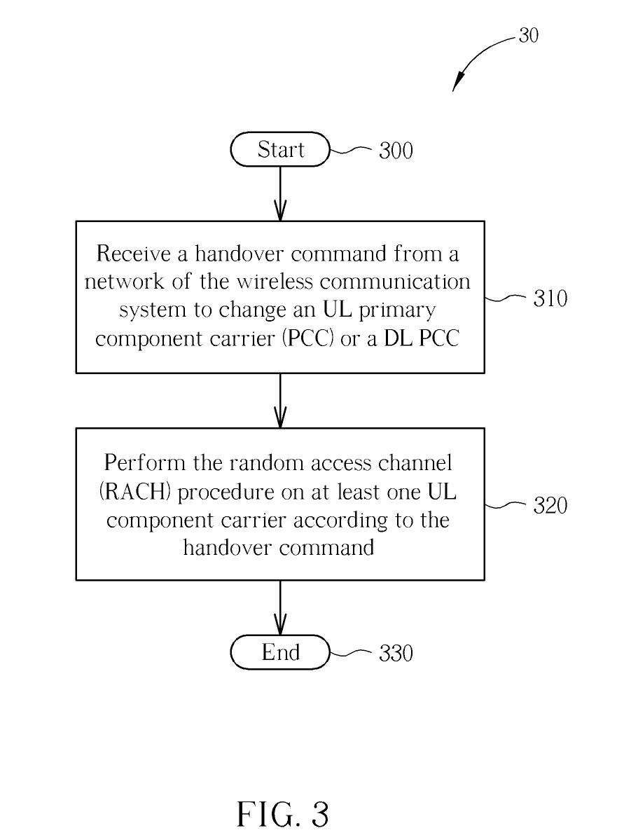

Please refer to FIG. 3, which is a flowchart of a process 30 according to an example of the present disclosure. The process 30 is utilized in a UE of a wireless communication system shown in FIG. 1. The process 30 may be compiled into the program code 214 and includes the following steps:

Step 300: Start.

Step 310: Receive a handover command from a network of the wireless communication system to change an UL primary component carrier (PCC) or a DL PCC.

Step 320: Perform the random access channel (RACH) procedure on at least one UL component carrier according to the handover command.

Step 330: End.

According to the process 30, the UE performs the RACH procedure on at least one UL component carrier according to the handover command when the UE receives the handover command from the eNB to change the configured UL PCC or the configured DL PCC. In detail, the UE may perform the RACH procedure on one or more UL component carriers which are determined in advance. Alternatively, the UE may perform the RACH procedure on one or more UL component carriers information of which is included in the handover command. Since the UE may know exactly which component carries the UE may perform RACH procedure on through the handover command, the change of the UL PCC or DL PCC can be achieved successfully.

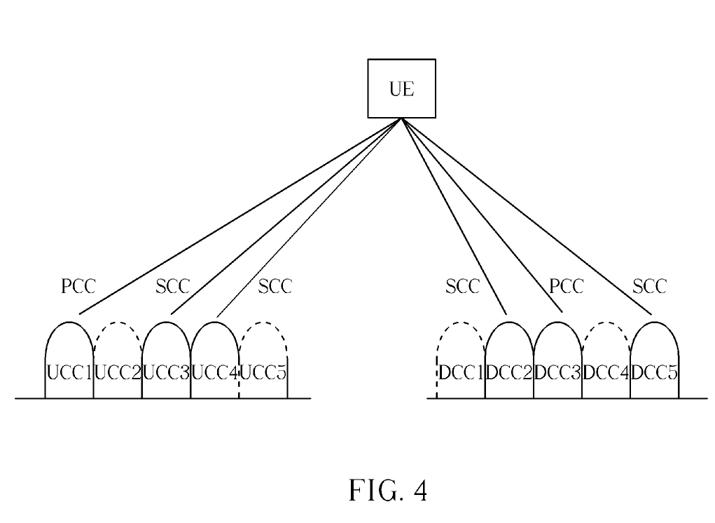

Please refer to FIG. 4, which is a schematic diagram of carrier aggregation according to an example of the present disclosure. There are 5 UL component carriers (termed as UCC1-UCC5) and 5 DL component carriers (termed as DCC1-DCC5). Among these component carriers, UCC1 is configured as the UL PCC to the UE, and DCC3 is configured as the DL PCC to the UE. UCC3 and UCC4 are configured as UL SCCs to the UE, and DCC2 and DCC5 are configured as DL SCCs to the UE. Other component carriers may be available to be configured, or have been configured to other UEs. Since each UL component carrier is paired a DL component carrier, each UCCn is paired with DCCn for ease of illustration, i.e., UCC1 is paired with DCC1 and so on, and the pairing rule is not limited herein.

When the UE receives the handover command with information of new UL component carriers and a notification to change the UL PCC or the DL PCC, the UE performs the RACH on a group of new UL component carriers. For example, if information of UCC2, UCC3 and UCC4 is included in the handover command, the UE performs the RACH on one, two or all of these UL component carriers. In detail, the UE may simply perform the RACH procedure on all new UL component carriers. Alternatively, the UE performs the RACH procedure on some of new UL component carriers, depending on the UE capability, reliability of the new UL component carriers, or/and power consumption of the UE. For example, the UE may be capable of performing the RACH procedure on at most two UL component carriers, and then the UE selects two of new UL component carriers, i.e., UCC2 and UCC4, to perform the RACH procedure on. Considering power consumption of the UE, even though the UE is capable of using all new UL component carriers, the UE only selects one or some of new UL component carriers to reduce the power consumption. Please note that, the selection strategy of above cases may depend on reliability of carriers or a predetermined rule, and is not limited herein.

When the UE receives the handover command with information of a new UL PCC and the notification to change the UL PCC or the DL PCC, the UE performs the RACH procedure on the new UL PCC. For example, if the UCC3 is configured as the new UL PCC to the UE in the handover command, the UE performs the RACH procedure on the UCC3.

When the UE receives the handover command with the notification to change the UL PCC or the DL PCC, it is possible that information of the new UL PCC is not included in the handover command. Then, the UE may arbitrarily select a configured UL component carrier to perform the RACH procedure on. In detail, the UE may select a configured UL component carrier based on the reliability of the configured UL component carrier. For example, if the UE determines that UCC3 is the most reliable configured UL component carrier, the UE performs the RACH procedure on UCC3. The reliability may be related to quality of a received signal at the eNB. The information of the reliability of configured UL component carriers maybe obtained from the feedback from the eNB and the method of obtaining information of the reliability is not limited herein. Please note that, the selection strategy may also be based on a predetermined rule, i.e., the UE always selects the configured UL PCC, and is not limited herein. Further, the UE may also perform the RACH procedure on an UL component carrier which is configured on a broadcasting control channel (BCCH), when information of the new UL PCC is not included in the handover command.

On the other hand, when the UE receives the handover command with the notification to change the UL PCC or the DL PCC, information of a new DL PCC is included instead of the new UL PCC in the handover command. Then, the UE performs the RACH procedure on an UL component carrier corresponding to the new DL PCC information of which is included in the handover command. For example, if DCC5 is configured as a new DL PCC in the handover command is, the UE performs the RACH procedure on the UCC5 since UCC5 is paired with DCC5 as mentioned above.

Please note that, consecutively grouped UL component carriers or DL component carriers shown in FIG. 4 are simply used for illustration. Component carriers can be aggregated non-consecutively, and UL component carriers and DL component carriers can even be arranged alternatively according to the radio resource configuration. The number of UL or DL component carriers is also not limited to 5, which is used for ease of illustration. In short, the arrangement and numbering of component carriers used in FIG. 4 are simply used for illustration and are not limited herein. Furthermore, each component carrier corresponds to a distinct frequency band when the wireless system operates in a frequency-division duplex (FDD) mode. When the wireless system operates in a time-division duplex (TDD) mode, i.e., UL and DL are separated in time but not frequency, a component carrier is used for both an UL component carrier and a DL component carrier. Thus, those skilled in the art should make different alterations and modifications according to a mode of operation, which are not limited herein.

Please note that, the abovementioned steps of the processes including suggested steps can be realized by means that could be a hardware, a firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include system on chip (SOC), system in package (SiP), a computer on module (COM), and the communication device 20.

In conclusion, the exemplary examples and means are provided for performing the RACH procedure when the handover command with a notification to change the UL PCC or the DL PCC is received. According to information included in the handover command, the UE selects at least one uplink component carrier to perform the RACH procedure on, so as to complete the procedure of changing PCC.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of changing a primary component carrier (PCC) for a mobile device in a wireless communication system, the method comprising:
receiving a handover command from a network of the wireless communication system to change a first uplink primary component carrier of a first plurality of uplink component carriers or a first downlink primary component carrier of a first plurality of downlink component carriers; and
performing a random access channel (RACH) procedure on at least one of uplink component carriers according to the handover command.

2. The method of claim 1, wherein performing the random access channel procedure on the at least one of uplink component carriers according to the handover command comprises performing the random access channel procedure on a component carrier of a second plurality of uplink component carriers when information of the second plurality of uplink component carriers is included in the handover command.

3. The method of claim 1, wherein performing the random access channel procedure on the at least one of uplink component carriers according to the handover command comprises performing the random access channel procedure on a second uplink primary component carrier of a second plurality of uplink component carriers when information of the second uplink primary component carrier is included in the handover command.

4. The method of claim 1, wherein performing the random access channel procedure on the at least one of uplink component carriers according to the handover command comprises performing the random access channel procedure on a component carrier of the first plurality of uplink component carriers when information of a second uplink primary component carrier is not included in the handover command.

5. The method of claim 1, wherein performing the random access channel procedure on the at least one of uplink component carriers according to the handover command comprises performing the random access channel procedure on an uplink component carrier configured on a broadcasting control channel (BCCH) when information of a second uplink primary component carrier is not included in the handover command.

6. The method of claim 1, wherein performing the random access channel procedure on the at least one of uplink component carriers according to the handover command comprises performing the random access channel procedure on an uplink component carrier corresponding to a second downlink primary component carrier of a second plurality of downlink component carriers when information of the second downlink primary component carrier is included in the handover command but information of a second uplink primary component carrier is not included in the handover command.

7. The method of claim 1, wherein in a time-division duplex (TDD) mode, a component carrier is used for both an UL component carrier and a DL component carrier.

8. A communication device of a wireless communication system for changing a primary component carrier (PCC), the communication device comprising:
a processor for executing a program; and
a memory coupled to the processor for storing the program; wherein the program instructs the processor to perform the following steps:
receiving a handover command from a network of the wireless communication system to change a first uplink primary component carrier of a first plurality of uplink component carriers or a first downlink primary component carrier of a first plurality of downlink component carriers; and
performing a random access channel (RACH) procedure on at least one of uplink component carriers according to the handover command.

9. The communication device of claim 8, wherein performing the random access channel procedure on the at least one of uplink component carriers according to the handover command comprises performing the random access channel procedure on a component carrier of a second plurality of uplink component carriers when information of the second plurality of uplink component carriers is included in the handover command.

10. The communication device of claim 8, wherein performing the random access channel procedure on the at least one of uplink component carriers according to the handover command comprises performing the random access channel procedure on a second uplink primary component carrier of a second plurality of uplink component carriers when information of the second uplink primary component carrier is included in the handover command.

11. The communication device of claim 8, wherein performing the random access channel procedure on the at least one of uplink component carriers according to the handover command comprises performing the random access channel procedure on a component carrier of the first plurality of uplink component carriers when information of a second uplink primary component carrier is not included in the handover command.

12. The communication device of claim 8, wherein performing the random access channel procedure on the at least one of uplink component carriers according to the handover command comprises performing the random access channel procedure on an uplink component carrier configured on a broadcasting control channel (BCCH) when information of a second uplink primary component carrier is not included in the handover command.

13. The communication device of claim 8, wherein performing the random access channel procedure on the at least one of uplink component carriers according to the handover command comprises performing the random access channel procedure on an uplink component carrier corresponding to a second downlink primary component carrier of a second plurality of downlink component carriers when information of the second downlink primary component carrier is included in the handover command but information of a second uplink primary component carrier is not included in the handover command.

14. The communication device of claim 8, wherein in a time-division duplex (TDD) mode, a component carrier is used for both an UL component carrier and a DL component carrier.
